(19) United States
(12) Patent Application Publication
(10) Pub. No.: US 2012/0026107 A1
(43) Pub. Date: Feb. 2, 2012

(54) TOUCH SCREEN PANEL AND DISPLAY DEVICE HAVING THE SAME

(75) Inventors: Chang-Bum KIM, Yongin-city (KR); Sung-Ku KANG, Yongin-city (KR)

(73) Assignee: SAMSUNG MOBILE DISPLAY CO., LTD., Yongin-city (KR)

(21) Appl. No.: 13/013,545

(22) Filed: Jan. 25, 2011

(30) Foreign Application Priority Data
Jul. 27, 2010 (KR) 10-2010-0072431

(51) Int. Cl. G06F 3/041

(52) U.S. Cl. 345/173

(57) ABSTRACT

Disclosed is a touch screen panel that can easily implement various colors along edges of the touch screen panel. A touch screen panel according to an embodiment of the present invention includes: a transparent substrate; conductive sensing cells formed in a touch active region on one side of the transparent substrate; and a decoration film attached to the other side of the transparent substrate and having a decoration layer overlapping a touch inactive region outside the touch active region.

### CROSS-REFERENCE TO RELATED APPLICATIONS

This application claims priority to and the benefit of Korean Patent Application No. 10-2010-0072431, filed on Jul. 27, 2010, in the Korean Intellectual Property Office, the entire content of which is incorporated herein by reference.

### BACKGROUND

1. Field of the Invention

An embodiment relates to a touch screen panel and an image display device having the same.

2. Discussion of Related Art

A touch screen panel is an input device that allows users to select contents displayed on a screen of an image display device, for example, using users' finger or an object to input commands of a user.

To this end, the touch screen panel is provided on a front face of the image display device and converts positional information of a contact into electrical signals.

Touch screen panels can replace other input devices such as a keyboard and a mouse, and the use of touch screen panels is expanding gradually.

Common touch screen panels include a black matrix formed in a touch inactive region along the edge of a touch active region. Thus, it is possible that position detecting lines under the touch inactive region may be prevented from being visualized.

As image display devices equipped with a touch screen panel recently implement various colors, a demand for implementing various colors for the edge of the touch screen panel has been increasing, and a study for easily implementing the various colors has been conducted.

Further, as the touch screen panel is used as an input means for portable display devices, it is required to reduce the thickness of the image display device quipped with the touch screen panel and ensure reliability for the thickness.

### SUMMARY

An embodiment of the present invention is to provide a touch screen panel that implements various colors for the edge and ensure reliability and an image display panel having the touch screen panel.

An aspect of the present invention provides a touch screen panel according to an embodiment of the present invention includes: a transparent substrate; conductive sensing cells formed in a touch active region on one side of the transparent substrate; and a decoration film attached to the other side of the transparent substrate and having a decoration layer overlapping a touch inactive region outside the touch active region.

In this configuration, the transparent substrate may be a window substrate positioned at the uppermost portion of substrates in an image display device to implement a window integral type touch screen panel.

Further, the decoration layer may include a base color layer. In this configuration, the color of the base color layer may be one selected from chromatic colors.

Further, the decoration layer may have a stacked structure composed of the chromatic color layer and one or more achromatic color layers positioned between the base color layer and the transparent substrate.

Further, the decoration layer may have a stacked structure composed of the chromatic color layer and a white color layer positioned between the base color layer and the transparent substrate.

Further, the decoration layer may have a stacked structure composed of the chromatic color layer and a black color layer positioned between the base color layer and the transparent substrate. Further, the decoration layer may further include a white color layer stacked between the base color layer and the black color layer.

Further, the conductive sensing cells may be formed on the bottom of the transparent substrate and the decoration film may be attached to the top of the transparent substrate.

Further, the decoration layer may be formed along the edge on one side of the decoration film.

Further, the touch screen panel may further include an adhesive layer positioned between the transparent substrate and the decoration film and attaching the decoration film to the transparent substrate.

Further, the decoration film may include a transparent film that is a base and the decoration film arranged along the edge on one side of the transparent film. In this configuration, the decoration layer may be formed on one side facing the transparent substrate of the transparent film.

Further, the touch screen panel may further include position detection lines formed in a touch inactive region on one side of the transparent substrate to over the decoration layer and electrically connected with the conductive sensing cells.

Another aspect of the present invention provides an image display device that includes: a display panel for displaying an image; and a touch screen panel receiving touch input, on the display panel, in which the touch screen panel includes: a transparent substrate where a touch active region and a touch inactive region outside the touch active region are defined; conductive sensing cells formed in a touch active region on one side of the transparent substrate; and a decoration layer attached to the other side of the transparent substrate and overlapping the touch inactive region.

In this configuration, the transparent substrate of the touch screen may be a window substrate that is disposed at the uppermost portion of substrates in the image display device and a contact member for touch input contacts.

Further, the decoration layer may include a chromatic base color layer.

Further, the decoration layer may have a stacked structure composed of the color layer and one or more achromatic color layers positioned between the base color layer and the transparent substrate.

Further, the conductive sensing cells may be formed on the bottom facing the display panel of the transparent substrate and the decoration film may be attached to the top of the transparent substrate.

Further, the decoration layer may be formed along the edge facing the transparent substrate of the decoration film.

According to the present invention described above, it is possible to ensure reliability of the touch screen panel by directly forming the conductive sensing cells on one side of the transparent substrate, which is a base of the touch screen panel. Further, it is possible to implement various colors for the touch screen and the edge of an image display device equipped with the touch screen panel through a relatively simple manufacturing process by attaching the adhesive film having a decoration layer at the edge to overlap the touch inactive region, on the other side of the transparent, opposite to the side where the conductive sensing cells are formed.

Further, as described above, a specific window substrate is not needed, because the conductive sensing cells are formed on one side of the transparent substrate, which is a base of the touch screen panel, and attaching a decoration film having an edge decoration layer to the other side, such that it is possible to use the transparent substrate of the touch screen as a window substrate. That is, according to the present invention, it is possible to reduce the thickness of the image display device equipped with the touch screen panel by integrating a window substrate with the transparent substrate of the touch screen panel.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a plan view schematically showing an example of a touch screen panel;

FIG. 2 is a cross-sectional view showing a touch screen panel according to an embodiment of the present invention;

FIG. 3 is a plan view showing a touch screen panel according to another embodiment of the present invention;

FIG. 4 is a cross-sectional view showing a touch screen panel according to another embodiment of the present invention;

FIG. 5 is a cross-sectional view showing a touch screen panel according to another embodiment of the present invention; and

FIG. 6 is a plan view schematically showing an image display device equipped with a touch screen panel according to an embodiment of the present invention.

### DETAILED DESCRIPTION OF EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

Hereinafter, embodiments of the present invention will be described in detail with reference to the accompanying drawings.

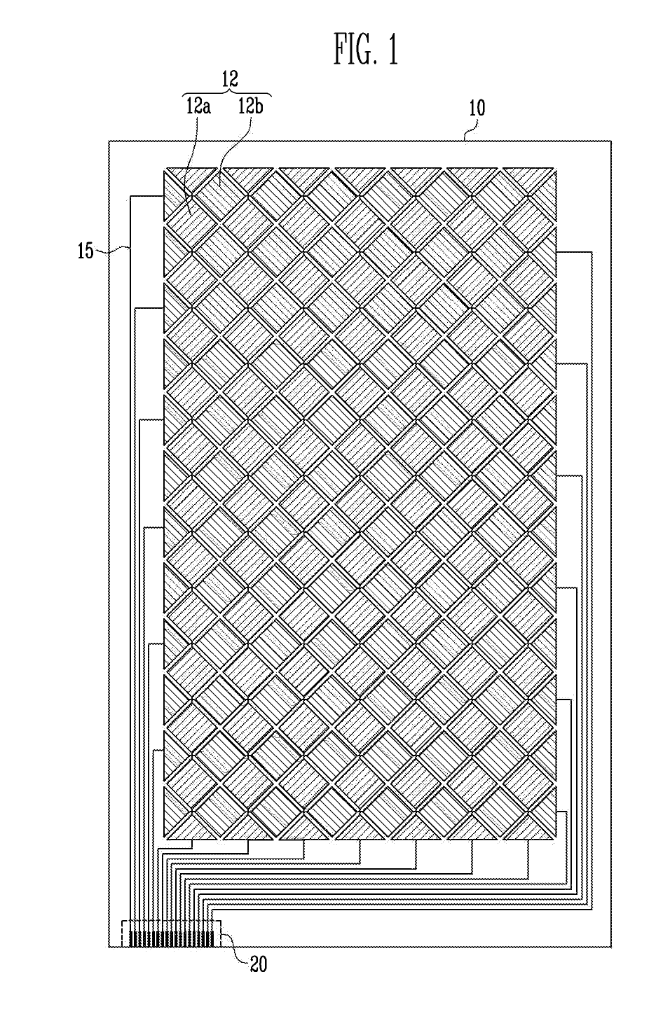

FIG. 1 is a plan view schematically showing an example of a touch screen panel.

Referring to FIG. 1, a touch screen panel includes a transparent substrate 10, a plurality of conductive sensing cells 12, and position detection lines 15. The plurality of conductive sensing cells 12 are formed on or over the transparent substrate 10. The position detection lines 15 electrically connect the conductive sensing cells 12 to a driving circuit of the touch screen panel. In the illustrated embodiment, the driving circuit is external to the touch screen panel and connected through a pad unit 20.

In embodiments, the transparent substrate 10 is a base member of the touch screen panel and may be formed of a substantially transparent substrate material, such as PET (PolyethyleneTerephthalate) or acryl. The transparent substrate has high transmittance of visible light and have up to 100% transparency.

In embodiments, the sensing cells 12 are made of a transparent electrode material, such as ITO, on or over a touch active region of the transparent substrate 10. In embodiments, the sensing cells 12 include first sensing cells 12a and second sensing cells 12b.

As illustrated, the first sensing cells 12a are those arranged in a vertical (column) direction on the drawing sheet and are electrically connected with each other. In embodiments, the touch screen panel includes a number of columns including electrically connected first sensing cells 12a. Each column of the first sensing cells 12a are also connected to one of the position detection lines 15.

Likewise, the second sensing cells 12b are those arranged in a horizontal (row) direction on the drawing sheet and are electrically connected with each other. In embodiments, the touch screen panel includes a number of rows including electrically connected second sensing cells 12b. Each row of the first sensing cells 12a are also connected to one of the position detection lines 15.

The first sensing cells 12a and the second sensing cells 12b may be respectively connected by first connecting patterns and second connecting patterns (not shown), with insulating layers therebetween, on the same layer, or may be disposed different layers, with insulating layers therebetween.

The position detection lines 15 connect the sensing cells 12 with an external driving circuit (not shown), such as a position detection circuit, through the pad unit 20.

In embodiments, the position lines 15 are disposed in a touch inactive region along the edge of a touch screen panel. The touch inactive region does not provide touch sensing and is an area outside a touch active region where an image is displayed and touch sensing is provided. The position lines 15 can be made of non-transparent conductive materials, such as Mo, Ag, Ti, Cu, Al, and Mo/Al/Mo.

The touch screen panel described above is a capacitive type touch screen panel, in which when a contact object, such as human's finger or a stylus pen contacts the touch screen panel, a change of electrostatic capacitance corresponding to the contact position is transmitted to the driving circuit (not shown) from the sensing cells 12 through the position detection lines 15 and the pad unit 20.

Further, the change in electrostatic capacity is converted into an electric signal by an X- and Y-input process circuit (not shown), such that the contact is located.

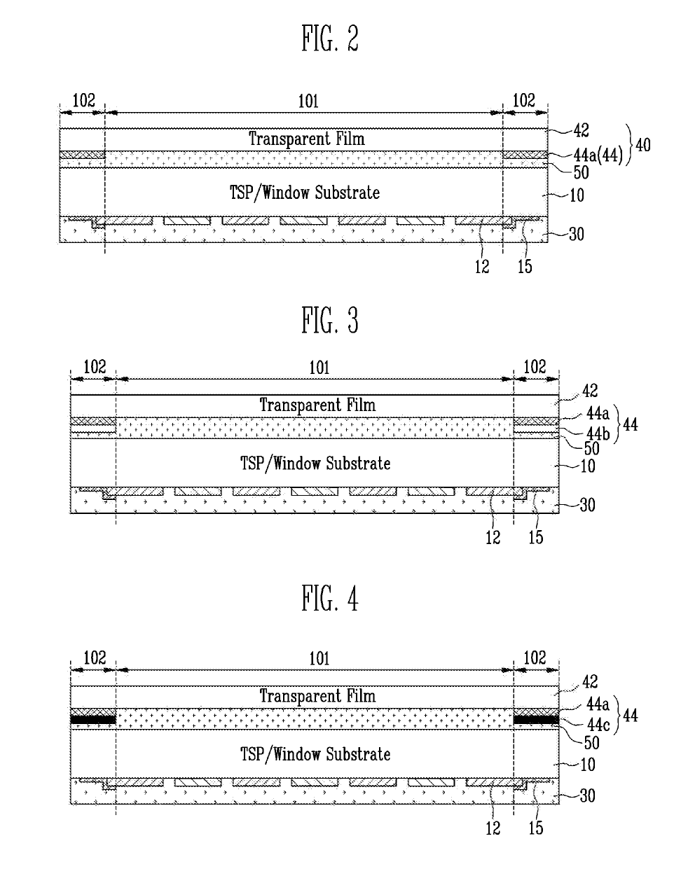

FIG. 2 is a cross-sectional view showing a touch screen panel according to an embodiment of the present invention.

Referring to FIG. 2, a touch screen panel 10 includes a passivation layer 30, a transparent substrate 10, and a decoration film 40. On the underside of the transparent substrate 10, conductive sensing cells 12 are formed in a touch active region 101. The decoration film 40 is attached to the other side of the transparent substrate 10 by an adhesive layer 50. The decoration film 40 includes a transparent film 102 and a decoration layer 44 that is located in a touch inactive region 102 defined outside the touch active region 101.

The transparent substrate 10 is a substrate that is the base member of the touch screen panel. In the alternative, the transparent substrate 10 may be a window substrate disposed at the uppermost position in substrates included in an image display device equipped with the touch screen panel.

That is, a touch screen panel and an integral window type touch screen panel which is equipped with a window can be achieved by forming patterns for implementing a touch screen on a window substrate. As described above, when a window is integrated with a touch screen panel, it is possible to reduce the thickness of an image display device equipped with the touch screen panel.

Meanwhile, in the integral window type touch screen panel, as an example, patterns for implementing the touch screen panel, that is, the conductive sensing cells 12 and the position detection lines 15 connected to the cells may be formed on a lower surface opposite to the touch surface (upper surface) of the transparent substrate 10.

In this configuration, the conductive sensing cells 12 are formed in the touch active region 101 overlapping the screen of an image display device and the position detection lines 15 are formed in the active inactive region 102 around the touch active region 101. Accordingly, the position detection lines 15 are disposed under the decoration layer 44 of the decoration film 40. Thus, the position detection lines 15 are not be seen from the outside.

The passivation layer 30 is formed on the underside of the transparent substrate 10 and cover the conductive sensing cells 12 and the position detection lines 15. Therefore, the transparent substrate 10, conductive sensing cells 12, position detection lines 15 are interposed between the decoration film 40 and the passivation layer 30.

As illustrated, the decoration film 40 is attached to the other side of the transparent substrate 10.

For example, the decoration film 40 having the decoration layer 42 at the edge may be attached to the top, the other side of the transparent substrate 10.

In embodiments, the decoration film 40 may include a transparent film 42 made of PET, which is the base of the decoration film 40, and the decoration layer 44 disposed along the edge of on one side of the transparent film 42. That is, the decoration layer 44 overlaps the touch inactive region 102 along the edge on one side of the decoration film 40, and for example, the decoration film 44 may be formed on the bottom of the transparent film 42, i.e. the side facing the transparent substrate 10 of the touch screen panel.

The color of the touch screen panel and the edge of an image display device equipped with the touch screen panel depends on the color of the decoration layer 44. In embodiments, the decoration layer 44 includes a base color layer 44a for implementing a predetermined color for the edge.

Any color can be chosen for the base color layer 44a. The color of the base cooler layer 44a is set as one color selected from various colors to provide various edge colors, not the black edges that are fixed in the related art.

Meanwhile, transparent substrate 10 and the decoration film 40 may be laminated with the adhesive layer 50 therebetween.

That is, the adhesive layer 50 is interposed between the transparent substrate 10 and the decoration film 40 to attach the decoration film 40 to the transparent substrate 10, and is made of a transparent adhesive to transmit light from the display panel (not shown) thereunder.

According to embodiments of the present invention, the conductive sensing cells 12 and the decoration film 40 are disposed on different sides of the transparent substrate 10, respectively. As illustrated, the conductive sensing cells 12 and the position detection lines 15 are formed on the bottom of the transparent substrate 10, and the decoration film 40 is attached to the top of the transparent substrate 10. Accordingly, the touch screen panel can be manufactured by providing the transparent substrate 10 having the sensing patterns on one side and the decoration film 40 having the decoration layer 44 on the other side of the transparent substrate 10 by lamination.

Having the conductive sensing cells 12 directly on one side of the transparent substrate 10 will provide various benefits, which include reduction of defects and improving the reliability of the touch screen panel. Further, since the decoration film 40 having the decoration layer 44 having various colors at the edge is attached to the other side of the transparent substrate 10, it is possible to manufacture a touch screen panel through a relatively simple process and easily implements various colors for the edge of an image display device equipped with the touch screen panel.

Further, since the conductive sensing cells 12 and the decoration film 40 are formed or attached to one transparent substrate 10, it is possible to use the transparent substrate 10 as a window substrate without a specific window substrate.

According to embodiments, since the integral window type touch screen panel is implemented by integrating the window substrate with the transparent substrate 10 of the touch screen panel, it is possible to reduce the thickness of an image display device.

Meanwhile, the decoration layer 44 of the decoration film 40 may have a stacked layer further including one or more achromatic color layers (not shown), other than the chromatic base color layer 44a. In this disclosure, achromatic colors refer to white, black or gray colors, whereas chromatic colors refer to all other colors.

In particular, the achromatic color layer may be positioned between the base color layer 44a and the transparent substrate 10 to prevent pattern-showing thereunder while implementing clear edge colors by the base color layer 44a, and various embodiments are described hereafter with reference to FIGS. 3 to 5.

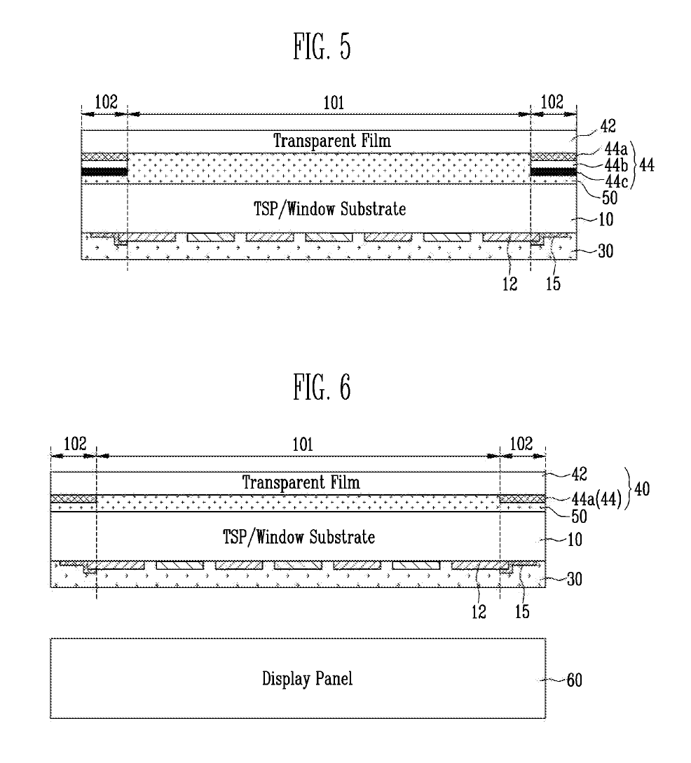

FIG. 3 is a cross-sectional view showing a touch screen panel according to another embodiment of the present invention, and FIGS. 4 and 5 are cross-sectional views showing touch screen panels according to other embodiments of the present invention. For the convenience of description, the same or similar components to those of FIG. 2 are not repeatedly described in describing FIGS. 3 to 5.

First, referring to FIG. 3, a decoration layer 44 may be formed by stacking a chromatic base color layer 44a for implementing various edge colors and a white color layer 44b positioned between the base color layer 44a and the transparent substrate 10.

When the white color layer 44b is further provided between the base color layer 44a and the transparent substrate 10, it is possible to effectively prevent pattern reflection of the touch inactive region 102 and implement clearer color for the base color layer 44a.

Further, as shown in FIG. 4, a decoration layer 44 may be formed by stacking a chromatic base color layer 44a and a black color layer 44c positioned between the base color layer 44a and the transparent substrate 10.

As described above, since the black color layer 44c is further provided between the base color layer 44a and the transparent substrate 10, it is possible more effectively prevent pattern reflection of the position detection lines 15 thereunder.

Further, as shown in FIG. 5, both of the white color layer 44b and the black color layer 44c may by provided.

For example, the decoration layer 44 may have a stacked structure composed of a chromatic base color layer 44a, a black color layer 44c and a white color layer 33b. In embodiments, the black color layer 44c is positioned between the base color layer 44a and the transparent substrate 10. In embodiments, the white color layer 33b is positioned between the base color layer 44a and the black color layer 44c. This configuration would more effectively prevent pattern reflection thereunder and make the color of the base color layer 44a clearer.

FIG. 6 is a plan view schematically showing an image display device equipped with a touch screen panel according to an embodiment of the present invention. For the convenience of description, FIG. 6 shows an image display device equipped with the touch screen panel shown in FIG. 2, and the same or similar components to those of FIG. 2 are not repeatedly described in describing FIG. 6.

Referring to FIG. 6, an image display device according to an embodiment of the present invention includes a display panel 60 for displaying an image and a touch screen receiving touch input on the display panel 60.

In this configuration, a touch active region 101 of the touch screen panel may be set to correspond to the display region of the display panel 60. Further, a touch inactive region 102 of the touch screen panel may be set to correspond to a non-display region 102 outside the display region of the display panel 60.

In embodiments, in an image display device, the touch screen panel and the window substrate are integrated.

In other words, the transparent substrate 10 may function as a window substrate that is positioned at the uppermost side in the substrate included in the image display device (except for the film, such as the decoration film, and a specific icon sheet) and a contact member for touch input while protecting the components contacts.

Therefore, in an image display device according to embodiments of the present invention, a specific window substrate is not needed and it is possible to reduce the thickness and the manufacturing cost.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and-equivalents thereof.

What is claimed is:

1. A touch screen panel comprising:
a transparent substrate comprising a first surface and a second surface facing away from the first surface;
conductive sensing cells formed over the first surface of the transparent substrate, wherein the conductive sensing cells define a touch active region configured to sense touches thereon; and
a decoration film formed over the second surface of the transparent substrate, wherein the decoration film comprises a decoration layer formed only in a touch inactive region, which is outside the touch active region when viewing in a direction perpendicular to the first surface.

2. The touch screen panel as claimed in claim 1, wherein the transparent substrate is a window substrate of an image display device.

3. The touch screen panel as claimed in claim 1, wherein the decoration layer comprises a base color layer.

4. The touch screen panel as claimed in claim 3, wherein the base color layer has a chromatic color, which is none of black, white and grays.

5. The touch screen panel as claimed in claim 3, wherein the decoration layer further comprises one or more achromatic color layers stacked over the base color layer, wherein the one or more achromatic color layers are positioned between the base color layer and the transparent substrate.

6. The touch screen panel as claimed in claim 3, wherein the decoration layer further comprises a white color layer stacked over the base color layer, wherein the white color layer is positioned between the base color layer and the transparent substrate.

7. The touch screen panel as claimed in claim 3, wherein the decoration layer further comprises a black color layer stacked over the base color layer, wherein the black color layer positioned between the base color layer and the transparent substrate.

8. The touch screen panel as claimed in claim 7, wherein the decoration layer further comprises a white color layer stacked between the base color layer and the black color layer.

9. The touch screen panel as claimed in claim 1, wherein the conductive sensing cells are formed on the first surface of the transparent substrate and the decoration film is attached to the second surface of the transparent substrate.

10. The touch screen panel as claimed in claim 9, wherein the decoration layer is formed along the edge of the decoration film.

11. The touch screen panel as claimed in claim 1, further comprising an adhesive layer positioned between the transparent substrate and the decoration film, the adhesive layer bonding attaching the decoration film to the transparent substrate.

12. The touch screen panel as claimed in claim 1, wherein the decoration film further comprises a transparent film substantially overlapping the transparent substrate when viewing in the direction perpendicular to the first surface, wherein the decoration layer is formed on a surface of the transparent film along an edge thereof.

13. The touch screen panel as claimed in claim 12, wherein the surface of the decoration film faces the transparent substrate.

14. The touch screen panel as claimed in claim 1, further comprising position detection lines electrically connected to the conductive sensing cells and formed in the touch inactive region over the first surface of the transparent substrate, wherein the decoration layer substantially overlaps the position detection lines when viewing in the direction perpendicular to the first surface.

15. An image display device comprising:
a display panel for displaying an image thereon; and
a touch screen panel configured to receive a touch input on the display panel,
wherein the touch screen panel comprises:
a transparent substrate having a touch active region and a touch inactive region outside the touch active region,
conductive sensing cells formed in the touch active region on a first surface of the transparent substrate, and
a decoration layer attached to a second surface of the transparent substrate facing away from the first surface, wherein the decoration layer is formed over the touch inactive region and not over the touch active region.

16. The image display device as claimed in claim 15, wherein the transparent substrate of the touch screen is a window substrate in the image display device and a contact member for touch input contacts.

17. The image display device as claimed in claim 15, wherein the decoration layer comprises a chromatic base color layer.

18. The image display device as claimed in claim 17, wherein the decoration layer has a stacked structure comprising the chromatic base color layer and one or more achromatic color layers positioned between the chromatic base base color layer and the transparent substrate.

19. The image display device as claimed in claim 15, wherein the conductive sensing cells are formed on the first surface facing the display panel of the transparent substrate, and wherein the decoration film is attached to the second surface facing away from the display panel.

20. The image display device as claimed in claim 19, wherein the decoration layer is formed along an edge of the transparent substrate.
